(19) United States
(12) Patent Application Publication
(10) Pub. No.: US 2016/0252170 A1
(43) Pub. Date: Sep. 1, 2016

(54) TORQUE CONVERTER DRIVE CONNECTION

(71) Applicant: Schaeffler Technologies AG & Co. KG, Herzogenaurach (DE)

(72) Inventors: Patrick Lindemann, Wooster, OH (US); Peter Rentfrow, Smithville, OH (US)

(73) Assignee: Schaeffler Technologies AG & Co. KG, Herzogenaurach (DE)

(21) Appl. No.: 14/963,027

(22) Filed: Dec. 8, 2015

Related U.S. Application Data
(60) Provisional application No. 62/089,787, filed on Dec. 9, 2014.

(51) Int. Cl. F16H 41/24; F04D 29/40; F04D 29/043; F16H 45/02; F04D 29/18

(52) U.S. Cl. CPC F16H 41/24; F16H 45/02; F04D 29/18; F04D 29/043; F04D 29/406; F16D 25/06

(57) ABSTRACT

A torque converter includes a cover arranged for driving engagement with a crankshaft and a connecting sleeve with an internal thread arranged for engaging an external thread of the cover or the crankshaft to directly connect the cover to the crankshaft. In some example embodiments, the connecting sleeve includes a cylindrical portion including the internal thread and a first radial wall disposed at a distal end of the cylindrical portion. In an example embodiment, the cover includes a hub portion with a pilot arranged for insertion into a recess of the crankshaft. In some example embodiments, the cover includes a face spline for engaging a crankshaft face spline or a conical surface for engaging a crankshaft conical surface.

### FIELD

The invention relates generally to a torque converter, and more specifically to a torque converter drive connection to an engine crankshaft.

### BACKGROUND

Connections to engine crankshafts are known from U.S. Pat. No. 6,830,140 to Zink et al., for example, hereby incorporated by reference as if set forth fully herein. Torque converter connections to engine crankshafts are known from commonly assigned United States Patent Application Publication No. 2012/0137669, for example, hereby incorporated by reference as if set forth fully herein.

### BRIEF SUMMARY

Example aspects broadly comprise a torque converter including a cover arranged for driving engagement with a crankshaft and a connecting sleeve with an internal thread arranged for engaging an external thread of the cover or the crankshaft to directly connect the cover to the crankshaft. In some example embodiments, the connecting sleeve includes a cylindrical portion including the internal thread and a first radial wall disposed at a distal end of the cylindrical portion. In an example embodiment, the cover includes a hub portion with a pilot arranged for insertion into a recess of the crankshaft. In some example embodiments, the cover includes a face spline for engaging a crankshaft face spline or a conical surface for engaging a crankshaft conical surface.

In some example embodiments, the cover includes a stamped shell and a hub portion, the hub portion is fixed to the stamped shell, and the hub portion includes the cover face spline or the cover conical surface. In an example embodiment, the hub portion includes a second radial wall and the connecting sleeve first radial wall is at least partially disposed between the hub portion second radial wall and the stamped shell.

In an example embodiment, the cover includes a drive plate fixed to the cover shell or the cover hub, the drive plate comprising the cover external thread and the cover face spline. In an example embodiment, the connecting sleeve cylindrical portion includes an external surface including a serrated portion, a series of axially extending grooves, a plurality of apertures, or a polygonal surface, for receiving a tool to fix the cover hub portion to the crankshaft. In an example embodiment, the connecting sleeve cylindrical portion includes a drive ring with a ring gear for engaging a starter motor pinion gear to fix the cover hub portion to the crankshaft. In an example embodiment, the torque converter has an impeller fixed to the cover. The impeller includes a hub arranged for driving connection with a transmission hydraulic pump.

Other example aspects broadly comprise a torque converter drive connection including a housing assembly, a crankshaft, and a connecting sleeve. The housing assembly has a cover fixed to an impeller. The cover has a cover shell, a first radially splined portion or a first conical surface, and a hub portion fixed to the cover shell and including a pilot. The crankshaft has an external thread, a second radially splined portion, complementary to and in driving engagement with the cover first radially splined portion, or a second conical surface, complementary to and in driving engagement with the cover first conical surface, and a recess. The connecting sleeve has an internal thread engaged with the crankshaft external thread.

In an example embodiment, the hub portion pilot is installed in the crankshaft recess. In some example embodiment, the hub portion has a first annular portion with first and second axially offset radial walls, the connecting sleeve has a cylindrical portion including the internal thread, and a second annular portion with a third radial wall disposed at a distal end of the cylindrical portion, and the hub portion first radial wall includes at least a portion of the cover radially splined portion or the cover conical surface and the connecting sleeve third radial wall is coplanar with the hub portion second radial wall. In an example embodiment, the connecting sleeve second annular portion is at least partially disposed between the hub portion second radial wall and the cover shell.

Other example aspects broadly comprise a torque converter drive connection including a housing assembly, a crankshaft, and a connecting sleeve. The housing assembly has a cover fixed to an impeller. The cover has a cover shell, a hub portion fixed to the cover shell and including a pilot, and a first drive plate fixed to the cover shell or the hub portion and including an external thread and a first radially splined portion or a first conical surface. The crankshaft has a second radially splined portion, complementary to and in driving engagement with the hub portion first radially splined portion, or a second conical surface, complementary to and in driving engagement with the hub portion first conical surface, and a recess. The connecting sleeve has an internal thread engaged with the hub portion external thread. In an example embodiment, the hub portion pilot is installed in the crankshaft recess.

In some example embodiments, the first drive plate comprises a first annular portion with a first radial wall including the first radially splined portion, the crankshaft comprises a second drive plate fastened to the crankshaft and including a second annular portion with first and second axially offset radial walls, the connecting sleeve comprises a cylindrical portion including the internal thread, and a third annular portion with a third radial wall disposed at a distal end of the cylindrical portion, and the crankshaft second drive plate first radial wall comprises at least a portion of the second radially splined portion and the connecting sleeve third radial wall is coplanar with the crankshaft second drive plate second radial wall. In an example embodiment, the crankshaft is installed in a combustion engine with a seal for sealing the crankshaft, and the connecting sleeve third annular portion is at least partially disposed between the seal and the crankshaft second drive plate second radial wall.

### BRIEF DESCRIPTION OF THE DRAWINGS

The nature and mode of operation of the present invention will now be more fully described in the following detailed description taken with the accompanying drawing figures, in which:

FIG. 1 is a top half cross section view of a torque converter drive connection according to an example aspect;

FIG. 2A is a detail section view of an alternative embodiment of the torque converter drive connection of FIG. 1;

FIG. 2B is a detail section view of an alternative embodiment of the torque converter drive connection of FIG. 1;

FIG. 3 is a top half cross section view of an alternative embodiment of a torque converter drive connection according to an example aspect.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

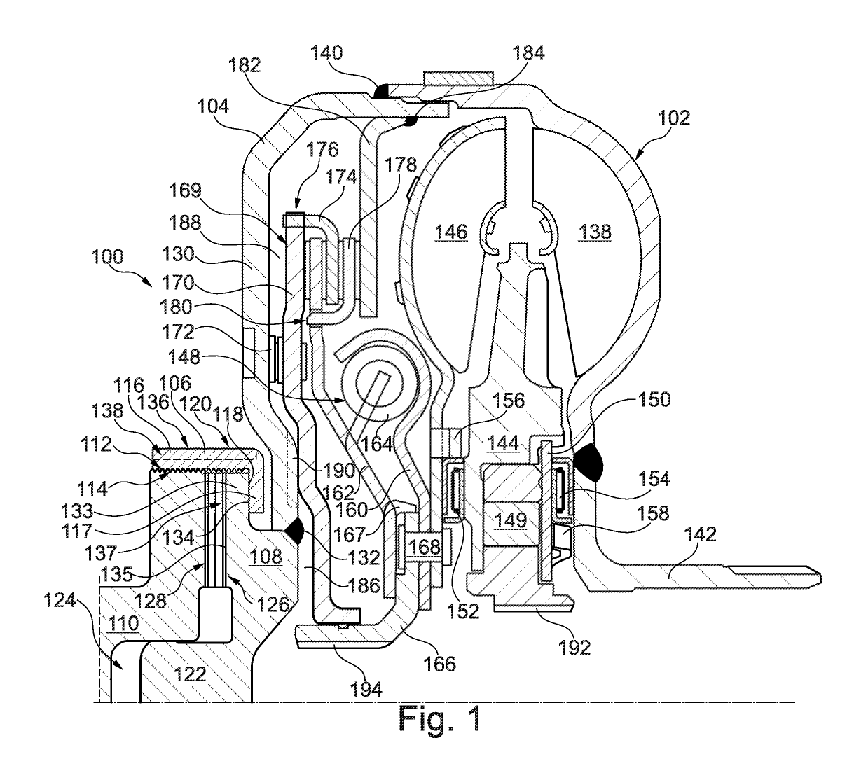

The following description is made with reference to FIG. 1. FIG. 1 is a top half cross section view of torque converter drive connection 100 according to an example aspect. Torque converter 102 includes cover 104 and connecting sleeve 106. Cover 104 is arranged for driving engagement with crankshaft 110 as will be described below. Connecting sleeve 106 includes internal thread 112 for engaging external thread 114 of crankshaft 110. Threads 112 and 114 aid in direct connection of cover 104 to crankshaft 110 as described below.

Connecting sleeve 106 includes cylindrical portion 116 with internal thread 112 and annular portion 117 with radial wall 118 disposed at end 120 of cylindrical portion 116. Cover 104 includes hub 108 with pilot 122 for insertion into recess 124 of crankshaft 110. Cover 104 includes face spline, or radially splined portion, 126 for engaging crankshaft face spline 128.

Face splines 126 and 128 are complementary and similar to complementary splines described in commonly-assigned U.S. Pat. No. 7,597,405, hereby incorporated by reference as if set forth fully herein. When properly assembled, splines 126 and 128 provide a lash-free driving connection between torque converter 102 and crankshaft 110. Assembly of face splines includes axially compressing each spline against the other (i.e. by tightening threaded sleeve 106 to crankshaft 110), creating a tight fit for torque transmission without rattle.

Cover 104 includes stamped shell 130. Hub portion 108 is fixed to shell 130 by weld 132, for example. Other embodiments (not shown) may include hub 108 fixed to the shell by riveting or removable fasteners, for example. Hub portion 108 includes face spline 126. Hub portion 108 includes annular portion 133 with axially offset radial walls 134 and 135. Radial wall 135 includes portion 137 of radially splined portion 126. Connecting sleeve radial wall 118 is disposed between wall 134 and shell 130. When torque converter 102 is assembled to crankshaft 110, radial wall 118 is coplanar with radial wall 134. Cylindrical portion 116 includes external surface 136 with serrated portion 138 for receiving a tool to fix the cover hub portion to the crankshaft. Other embodiments (not shown) may include a series of axially extending grooves, a plurality of apertures or a polygonal surface on external surface 136.

Torque converter 102 includes impeller 138 fixed to cover 104 at weld 140, creating a housing assembly. Impeller 138 includes hub 142 for driving connection with a transmission hydraulic pump (not shown) as is known in the art. Converter 102 further includes stator assembly 144, turbine 146, and damper assembly 148. Stator assembly 144 includes one way clutch 149 and side plate 150. Bearings 152 and 154 are disposed axially between stator 144 and turbine 146, and impeller 138 and side plate 148, respectively. Turbine 146 includes axial protrusion 156 and side plate 148 includes axial protrusion 158 for radial centering of bearings 152 and 154, respectively. Damper assembly 148 includes retainer plate 160 and clutch drive plate 162, each of which are drivingly engaged with spring 164. Hub 166 is fixed to turbine 146 and damper plate 156 via rivet 168. Clutch drive plate 162 includes protrusion 167 for radial centering on hub 166.

Clutch assembly 169 includes piston 170 drivingly engaged with cover 104 via riveted leaf springs 172, clutch plate 174 drivingly engaged with the piston at tabbed section 176, and clutch plate 178 drivingly engaged with damper clutch drive plate 162 at tabbed section 180. Backing plate 182 is fixed to cover 104 at weld 184. Piston 170 is sealed to hub 166 and compresses the clutch plates against the backing plate to engage the clutch. Piston 170 is hydraulically applied via fluid introduced into chamber 186 and 188, connected via cover groove 190. One way clutch 146 includes splines 192 for driving engagement with a transmission stator shaft (not shown) and hub 166 includes splines 194 for driving engagement with a transmission input shaft (not shown).

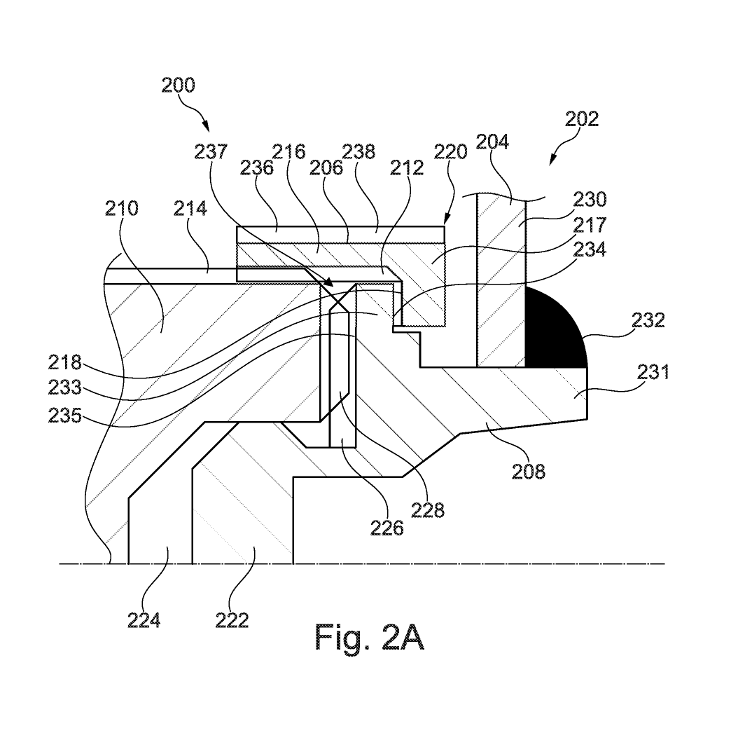

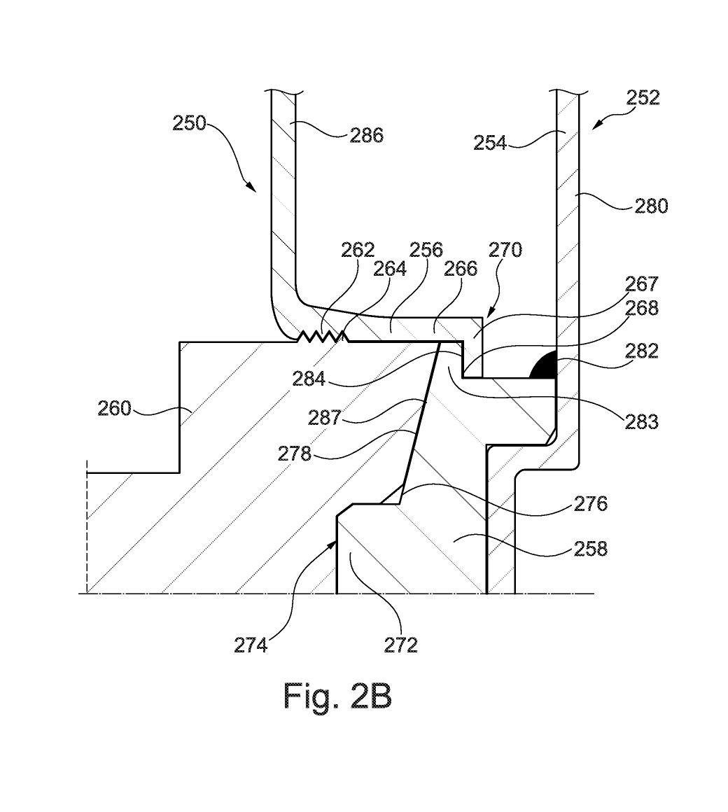

The following description is made with reference to FIG. 2A. FIG. 2A is a detail section view of alternative embodiment 200 of torque converter drive connection 100 of FIG. 1. Torque converter 202 includes cover 204 and connecting sleeve 206. Cover 204 is arranged for driving engagement with crankshaft 210 as will be described below. Connecting sleeve 206 includes internal thread 212 for engaging external thread 214 of crankshaft 210. Threads 212 and 214 aid in direct connection of cover 204 to crankshaft 210 as described below.

Connecting sleeve 206 includes cylindrical portion 216 with internal thread 212 and annular portion 217 with radial wall 218 disposed at end 220 of cylindrical portion 216. Cover 204 includes hub 208 with pilot 222 for insertion into recess 224 of crankshaft 210. Cover 204 includes face spline 226 for engaging crankshaft face spline 228. Face splines 226 and 228 are complementary and similar to complementary splines described in commonly-assigned U.S. Pat. No. 7,597,405, hereby incorporated by reference as if set forth fully herein. When properly assembled, splines 226 and 228 provide a lash-free driving connection between torque converter 202 and crankshaft 210. Assembly of face splines includes axially compressing each spline against the other (i.e. by tightening threaded sleeve 206 to crankshaft 210), creating a tight fit for torque transmission without rattle.

Cover 202 includes stamped shell 230. Hub portion 208 is fixed to shell 230 by weld 232, for example, at cylindrical portion 233. Other embodiments (not shown) may include hub 208 fixed to the shell by riveting or removable fasteners, for example. Hub portion 208 includes face spline 226. Hub portion 208 includes annular portion 233 with axially offset radial walls 234 and 235. Radial wall 235 includes portion 237 of radially splined portion 226.

Connecting sleeve radial wall 218 is disposed between wall 234 and shell 230. Cylindrical portion 216 includes external surface 236 with serrated portion 238 for receiving a tool to fix the cover hub portion to the crankshaft. Other embodiments (not shown) may include a series of axially extending grooves, a plurality of apertures or a polygonal surface on external surface 236.

The following description is made with reference to FIG. 2B. FIG. 2B is a detail section view of alternative embodiment 250 of torque converter drive connection 100 of FIG. 1. Torque converter 252 includes cover 254 and connecting sleeve 256. Cover 254 is arranged for driving engagement with crankshaft 260 as will be described below. Connecting sleeve 256 includes internal thread 262 for engaging external thread 264 of crankshaft 260. Threads 262 and 264 aid in direct connection of cover 254 to crankshaft 260 as described below.

Connecting sleeve 256 includes cylindrical portion 266 with internal thread 262 and annular portion 267 with radial wall 268 disposed at end 270 of cylindrical portion 266. Cover 254 includes hub 258 with pilot 272 for insertion into recess 274 of crankshaft 260. Cover 254 includes conical surface 276 for engaging crankshaft conical surface 278. Conical surfaces 276 and 278 are complementary. When properly assembled, surfaces 276 and 278 provide a lash-free driving connection between torque converter 252 and crankshaft 260. Assembly of the conical surfaces includes axially compressing each surface against the other (i.e. by tightening threaded sleeve 256 to crankshaft 260), creating a tight fit for torque transmission without rattle.

Cover 252 includes stamped shell 280. Hub portion 258 is fixed to shell 280 by weld 282, for example, at cylindrical portion 283. Other embodiments (not shown) may include hub 258 fixed to the shell by riveting or removable fasteners, for example. Hub portion 258 includes conical surface 276. Hub portion 258 includes annular portion 283 with axially offset radial wall 284 and wall 285. Wall 285 includes portion 287 of conical surface 276. Connecting sleeve radial wall 268 is disposed between wall 284 and shell 280. Cylindrical portion 266 includes drive ring 286 with a ring gear (not shown) for engaging a starter motor pinion gear (not shown) to fix the cover hub portion to the crankshaft. That is, when assembling the engine with a transmission, the torque converter can be assembled to the crankshaft by engaging a starter motor to spin the connector sleeve, threading the sleeve onto the crankshaft and compressing the conical surfaces. Advantageously, assembly time is decreased and no additional tools are required.

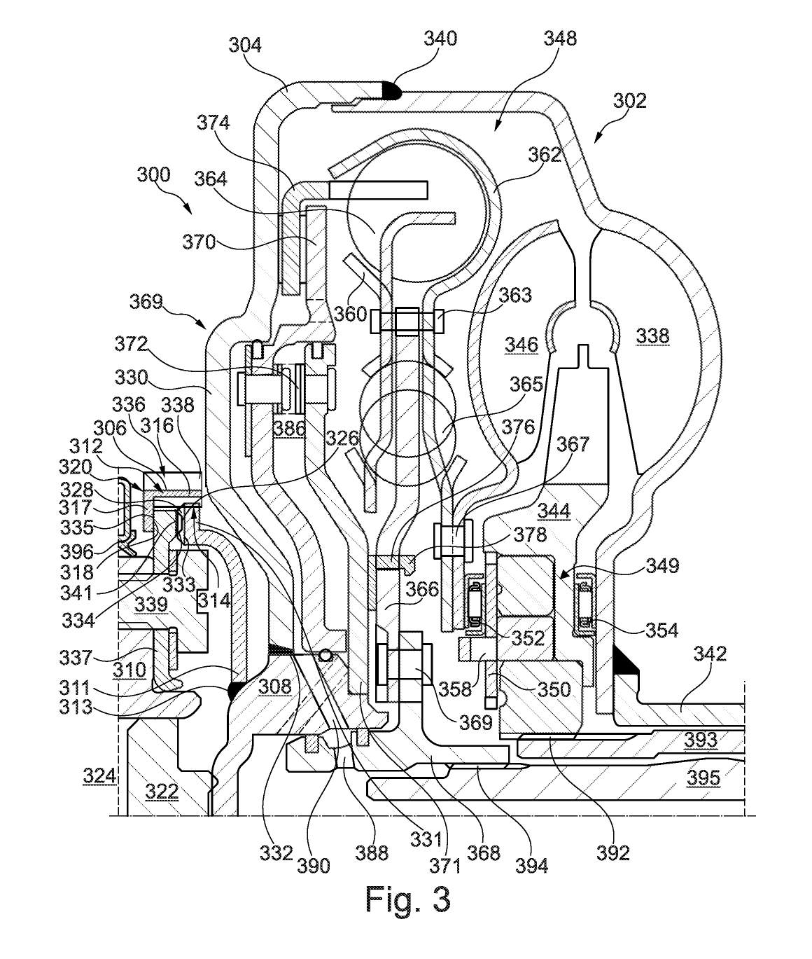

The following description is made with reference to FIG. 3. FIG. 3 is a top half cross section view of torque converter drive connection 300 according to an example aspect. Torque converter 302 includes cover 304 and connecting sleeve 306. Cover 304 is arranged for driving engagement with crankshaft 310 as will be described below. Cover 304 includes shell 330 and hub portion 308 fixed to cover shell 330 by weld 332, for example, and drive plate 311 fixed to cover hub 308 at weld 313. Other embodiments (not shown) may include the drive plate fixed by rivets or removable fasteners, or fixed to cover shell. Connecting sleeve 306 includes internal thread 312 for engaging external thread 314 of drive plate 311. Threads 312 and 314 aid in direct connection of cover hub 308 to crankshaft 310 as described below.

Connecting sleeve 306 includes cylindrical portion 316 with internal thread 312 and annular portion 317 with radial wall 318 disposed at end 320 of cylindrical portion 316. Cover hub 308 includes pilot 322 for insertion into recess 324 of crankshaft 310. Cover 304 includes face spline, or radially splined portion, 326 for engaging crankshaft face spline 328. Face splines 326 and 328 are complementary and similar to complementary splines described in commonly-assigned U.S. Pat. No. 7,597,405, hereby incorporated by reference as if set forth fully herein. When properly assembled, splines 326 and 328 provide a lash-free driving connection between torque converter 302 and crankshaft 310. Assembly of face splines includes axially compressing each spline against the other (i.e. by tightening threaded sleeve 306 to drive plate 311), creating a tight fit for torque transmission without rattle.

Drive plate 311 includes annular portion 333 with radial wall 335 including radially splined portion 326. Crankshaft 310 includes drive plate 337 fastened to the crankshaft by bolts 339, for example. Drive plate 337 includes annular portion 341 with axially offset radial walls 334 and 335. Wall 343 includes crankshaft face spline 328. When torque converter 302 is assembled to crankshaft 310, radial wall 318 is coplanar with radial wall 334. Crankshaft 310 is installed in a combustion engine (not shown) with seal 396 for sealing the crankshaft. Connecting sleeve annular portion 317 is partially disposed between the seal drive plate 337 radial wall 335.

Cylindrical portion 316 includes external surface 336 with serrated portion 338 for receiving a tool to fix the cover hub portion to the crankshaft. Other embodiments (not shown) may include a series of axially extending grooves, a plurality of apertures or a polygonal surface on external surface 136.

Torque converter 302 includes impeller 338 fixed to cover 304 at weld 340, creating a housing assembly. Impeller 338 includes hub 342 for driving connection with a transmission hydraulic pump (not shown) as is known in the art. Converter 302 further includes stator assembly 344, turbine 346, and damper assembly 348. Stator assembly 344 includes one way clutch 349 and side plate 350. Bearings 352 and 354 are disposed axially between turbine 346 and side plate 348, and impeller 338 and stator 344, respectively. Side plate 348 includes axial protrusion 358 for radial centering of bearing 352. Damper assembly 348 includes retainer plates 360 and 362, fixed together by rivet 363. Plate 360 is drivingly engaged with springs 364 and 365. Plate 362 is drivingly engaged with spring 365 and fixed to turbine 346 via rivet 367. Damper assembly 348 includes flange 366 drivingly engaged with spring 365 and hub 368 fixed to flange 366 via rivet 369.

Clutch assembly 369 includes piston 370 drivingly engaged with backing plate 371 via riveted leaf springs 372, and clutch plate 374 drivingly engaged with spring 364. Backing plate 371 is fixed to hub 308. Thrust washer 376 is disposed axially between plate 371 and flange 366, and retained in flange 366 via snap connection 378.

Hub 368 is sealed to hub 308. Piston 370 is sealed to hub 308 and compresses the clutch plate against the cover to engage the clutch. Piston 370 is hydraulically applied via fluid introduced into chamber 386 through hub grooves 388 and 390. One way clutch 346 includes splines 392 for driving engagement with transmission stator shaft 393 and hub 368 includes splines 394 for driving engagement with transmission input shaft 395.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What I claim is:

1. A torque converter comprising:
a cover arranged for driving engagement with a crankshaft; and,
a connecting sleeve including an internal thread arranged for engaging an external thread of the cover or the crankshaft to directly connect the cover to the crankshaft.

2. The torque converter of claim 1 wherein the connecting sleeve includes a cylindrical portion including the internal thread and a first radial wall disposed at a distal end of the cylindrical portion.

3. The torque converter of claim 2 wherein the cover comprises a hub portion with a pilot arranged for insertion into a recess of the crankshaft.

4. The torque converter of claim 2 wherein the cover comprises a face spline for engaging a crankshaft face spline or a conical surface for engaging a crankshaft conical surface.

5. The torque converter of claim 4 wherein the cover comprises a stamped shell and a hub portion, the hub portion is fixed to the stamped shell, and the hub portion comprises the cover face spline or the cover conical surface.

6. The torque converter of claim 5 wherein the hub portion includes a second radial wall and the connecting sleeve first radial wall is at least partially disposed between the hub portion second radial wall and the stamped shell.

7. The torque converter of claim 4 wherein the cover comprises a drive plate fixed to the cover shell or the cover hub, the drive plate comprising the cover external thread and the cover face spline.

8. The torque converter of claim 2 wherein the connecting sleeve cylindrical portion includes an external surface including a serrated portion, a series of axially extending grooves, a plurality of apertures, or a polygonal surface, for receiving a tool to fix the cover hub portion to the crankshaft.

9. The torque converter of claim 2 wherein the connecting sleeve cylindrical portion includes a drive ring with a ring gear for engaging a starter motor pinion gear to fix the cover hub portion to the crankshaft.

10. The torque converter of claim 2 further comprising an impeller fixed to the cover, wherein the impeller includes a hub arranged for driving connection with a transmission hydraulic pump.

11. A torque converter drive connection comprising:
a housing assembly including a cover fixed to an impeller, the cover comprising:
a cover shell;
a first radially splined portion or a first conical surface; and,
a hub portion fixed to the cover shell and including a pilot;
a crankshaft including:
an external thread;
a second radially splined portion, complementary to and in driving engagement with the cover first radially splined portion; or,
a second conical surface, complementary to and in driving engagement with the cover first conical surface; and,
a recess; and,
a connecting sleeve including an internal thread engaged with the crankshaft external thread.

12. The torque converter drive connection of claim 11 wherein the hub portion pilot is installed in the crankshaft recess.

13. The torque converter drive connection of claim 11 wherein:
the hub portion comprises a first annular portion with first and second axially offset radial walls;
the connecting sleeve comprises a cylindrical portion including the internal thread, and a second annular portion with a third radial wall disposed at a distal end of the cylindrical portion; and,
the hub portion first radial wall comprises at least a portion of the cover radially splined portion or the cover conical surface and the connecting sleeve third radial wall is coplanar with the hub portion second radial wall.

14. The torque converter drive connection of claim 13 wherein:
the connecting sleeve second annular portion is at least partially disposed between the hub portion second radial wall and the cover shell.

15. A torque converter drive connection comprising:
a housing assembly including a cover fixed to an impeller, the cover comprising:
a cover shell;
a hub portion fixed to the cover shell and including a pilot; and,
a first drive plate fixed to the cover shell or the hub portion and including an external thread and a first radially splined portion or a first conical surface;
a crankshaft including:
a second radially splined portion, complementary to and in driving engagement with the hub portion first radially splined portion; or,
a second conical surface, complementary to and in driving engagement with the hub portion first conical surface; and,
a recess; and,
a connecting sleeve including an internal thread engaged with the hub portion external thread.

16. The torque converter drive connection of claim 15 wherein the hub portion pilot is installed in the crankshaft recess.

17. The torque converter drive connection of claim 15 wherein:
the first drive plate comprises a first annular portion with a first radial wall including the first radially splined portion;
the crankshaft comprises a second drive plate fastened to the crankshaft and including a second annular portion with first and second axially offset radial walls;
the connecting sleeve comprises a cylindrical portion including the internal thread, and a third annular portion with a third radial wall disposed at a distal end of the cylindrical portion; and,
the crankshaft second drive plate first radial wall comprises at least a portion of the second radially splined portion and the connecting sleeve third radial wall is coplanar with the crankshaft second drive plate second radial wall.

18. The torque converter drive connection of claim 17 wherein:
the crankshaft is installed in a combustion engine with a seal for sealing the crankshaft; and,
the connecting sleeve third annular portion is at least partially disposed between the seal and the crankshaft second drive plate second radial wall.
